(19) United States
(12) Patent Application Publication
(10) Pub. No.: US 2011/0078578 A1
(43) Pub. Date: Mar. 31, 2011

(54) INTERACTIVE AVATAR

(76) Inventor: Sam Calis, Pasadena, CA (US)

(21) Appl. No.: 12/767,792

(22) Filed: Apr. 26, 2010

Related U.S. Application Data
(60) Provisional application No. 61/172,681, filed on Apr. 24, 2009.

(51) Int. Cl. G06F 3/01

(52) U.S. Cl. 715/740

(57) ABSTRACT

An interactive avatar is disclosed. This avatar is an animated character created by a user and is capable of carrying out the user's instructions, both in real time and as a predefined script, in applications such as computer screens (“desktops”) or smartphones. The avatar exists in one place at a time, and may freely move to the applications of other willing participants. While the acts are essentially harmless, other users have the ability to restrict or control the actions allowed on their applications, as well as to reverse the effects of others' avatars.

### CROSS-REFERENCE TO RELATED APPLICATION(S)

This application claims priority to and the benefit of U.S. Provisional Patent Application No. 61/172,681, entitled “Interactive Avatar,” filed on Apr. 24, 2009 in the U.S. Patent and Trademark Office, the entire content of which is herein incorporated by reference.

### BACKGROUND

An avatar is used to represent a person, user, or party in a computer or communications application, such as a computer game, an online forum, a virtual world, a video call, or the like. An avatar allows the person to express them self within the application, be it by visual appearance, animated acts, accompanying text or speech, etc. An avatar can take on many forms, depending on the application, such as the person themselves, or an imaginary person, a real or imaginary creature, or the like. Avatars can be fixed, as in a picture attached to a message posting, or animated, such as a customized video game character or a talking figure that speaks the words of a party on a video call or instant messaging program. Avatars serve to identify or distinguish the person to other users.

Avatars can be customized to appeal to users of all ages. Avatars can be nearly faithful reproductions of their corresponding users or some fanciful alter egos. They can be cartoon or lifelike, and resemble any object, living or dead. Avatars can be quite sophisticated in virtual world settings. Avatars can be used for a wide variety of applications, such as social networking, interactive gaming, or just plain fun.

There is a need for avatars that allow willing participants to more freely express themselves on common applications like computer screens (“desktops”) and other video applications, such as smartphones or video calls, belonging to other willing participants.

### SUMMARY

An interactive avatar client application is disclosed. This client application is designed to be implemented on a plurality of electronic systems or devices interconnected through a communications network, such as the Internet. An interactive avatar is an animated character created for a user and is capable of carrying out the user's instructions, both in real time and as a predefined script. These actions take place in applications such as computer screens (“desktops,” such as Windows or Mac), smartphones (such as an iPhone), personal digital assistants (PDAs), and the like, belonging to either the user or to other users with their permission. Each such application is actually a separate instance of the client application that implements the interactive avatar using the application programming interfaces (APIs) of the hosting application (be it a Windows desktop, an iPhone, a Mac, or the like). Each individual avatar might exist in one place at a time (a “host” system or device), and may move from application to application (i.e., from one host to another, or to put it another way, from one client to another) at the user's discretion. A single user is free to have multiple avatars, each potentially located on a different application. In addition, the client application is capable of running multiple such avatars, belonging to the same or different users, all on the same system.

In an exemplary embodiment, the avatar interacts with another user's desktop, doing various acts such as moving windows or icons, playing games (such as chess or real-time trivia or video games), performing animated gestures, or communicating in text or speech, either under the direct control of the user or through automated scripts. The acts and their effects are essentially harmless, and reversible by the other user. Privacy is protected by only sharing the other user's screen characteristics, such as location and size of windows, and not the content of such windows. The acts of the avatar can be selectively controlled by the other user to customize the level of disruption permitted.

In another exemplary embodiment, the avatars represent protected works (such as by copyright) and are rented to users by their owners for the users' personal use. They may also be distributed at no cost, subject to potential marketing opportunities by the owner. For instance, a Disney character might occasionally make a comment about a Disney product or resort to the user's desktop on which the avatar is currently appearing. Companies interested in using such tools for marketing have the capability to control the ability of people to use the avatars (i.e., how their appearance can be altered, or the content of the communication that can emanate from the avatar). This preserves the owner's desires to preserve consistent appearance of their works while allowing users the ability to have customized access to otherwise protected works.

In still another embodiment, the avatars can be programmed by the users to do specific acts or take on various appearances through the interactive avatar API. In addition, users can (possibly for a fee) enhance their avatars through adding functions or visual features.

### BRIEF DESCRIPTION OF THE DRAWINGS

The accompanying drawings illustrate embodiments of the present invention, and together with the description, serve to explain the principles of the embodiments of the present invention.

FIG. 1 depicts some example avatars that can be downloaded to appear on another user's system, according to an exemplary embodiment of the present invention.

FIG. 2 illustrates a pair of avatars representing two friends, each avatar appearing on the friend's system, according to an embodiment of the present invention.

FIG. 3 shows an example avatar and game application running on a user's desktop, according to an embodiment of the present invention.

FIG. 4 depicts an example text messaging application that can be run in conjunction with an exemplary embodiment of the present invention.

FIG. 5 illustrates a sample advertisement that can be displayed alongside an active avatar in an embodiment of the present invention.

### DETAILED DESCRIPTION

Now, exemplary embodiments of the present invention will be described in more detail with reference to the accompanying drawings. In the drawings, like reference numerals refer to like elements throughout.

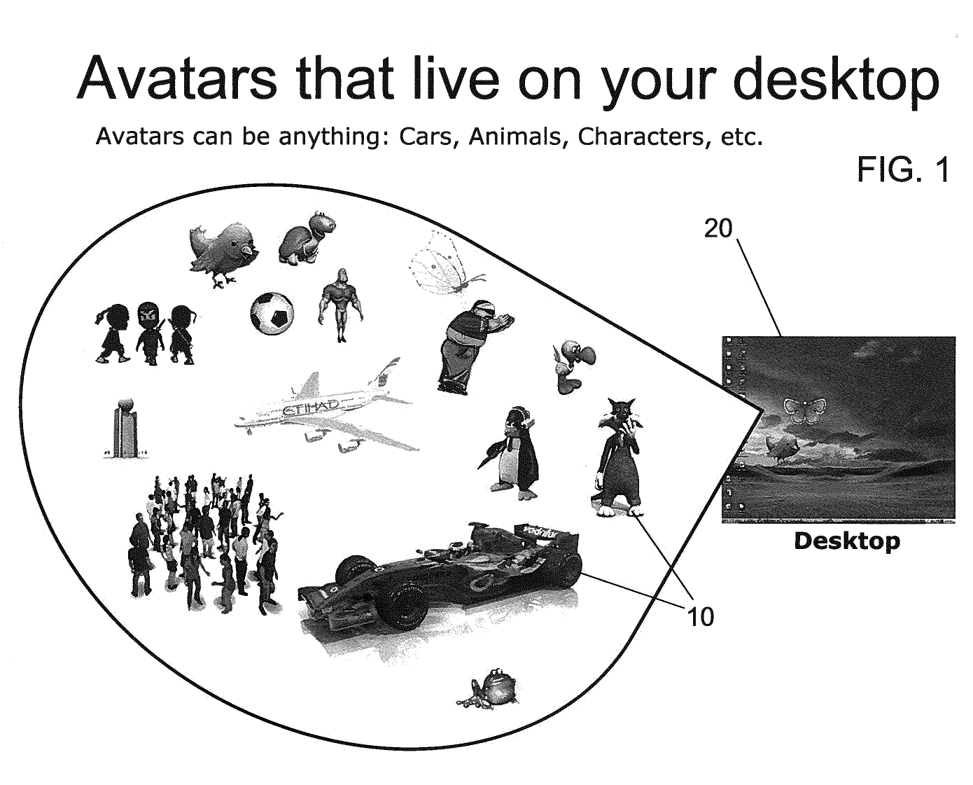

An interactive avatar can be imported from a virtual world, instant messaging application, or the like, and made to operate under a user's control on another user's computer or communications applications, such as a computer screen (“desktop”), smartphone, voice over internet protocol (VoIP) application, personal digital assistant (PDA), etc. The avatar is a two-dimensional graphical depiction of some person, animal, object, or other entity. For example, FIG. 1 displays example avatars 10, which can operate on an example desktop 20. The avatars 10 are capable of operating under the control of the user, through such devices using, for example, a menu of preprogrammed scripts or actions (e.g., desktop interactions, games, text, and speech). Additional scripts may be available, possibly for a fee. The user is also free to program the avatar's scripts themselves, should more customization or activities be desired.

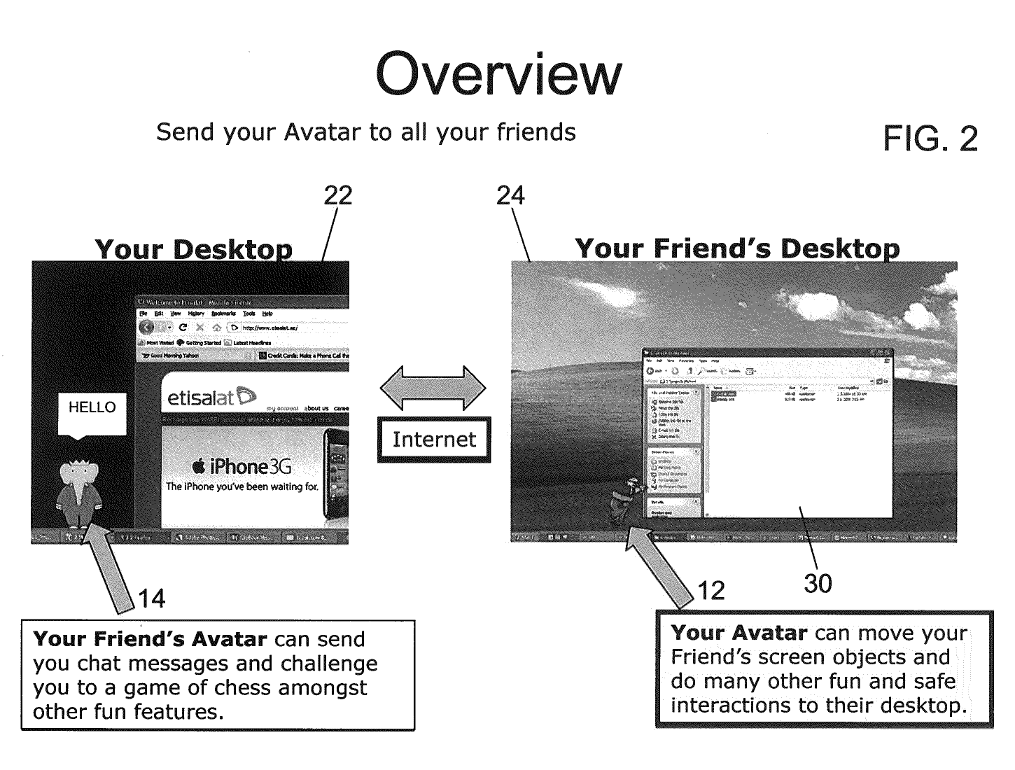

Interactive avatars work on computer hardware and other computer-like devices, such as smartphones and PDAs. They are implemented as a client application on the hosting device, using the API of the hosting device (be it Windows, an iPhone, Mac, etc.). They can perform useful functions involving communication, marketing, and the like. They can thus transform people's thoughts and ideas into more tangible expressions, such as voice and text communications, that touch other people's everyday lives in common environments, such as offices, homes, and anywhere that can be reached by wireless networks. For instance, interactive avatars can be shared by two different users, where each user's avatar appears on the other user's system, as depicted in FIG. 2. In FIG. 2, one user's avatar 12 appears on their friend's desktop 24, while their friend's avatar 14 appears on the user's desktop 22. The user's avatar 12 is “pushing” a desktop window 30 to another portion of the friend's desktop 24.

The actual interactive avatars can be provided by service providers, who may charge a fee or be compensated in other ways (such as through advertising). These avatars are then “brought to life” by the network of client applications (hosting systems, interconnected through a communications network, such as the Internet) on which the avatars can populate. The service providers, in turn, provide use of an avatar to a user, with characteristics (e.g., appearance, behaviors, etc.) that can be customized by the user. Each interactive avatar can thus be unique.

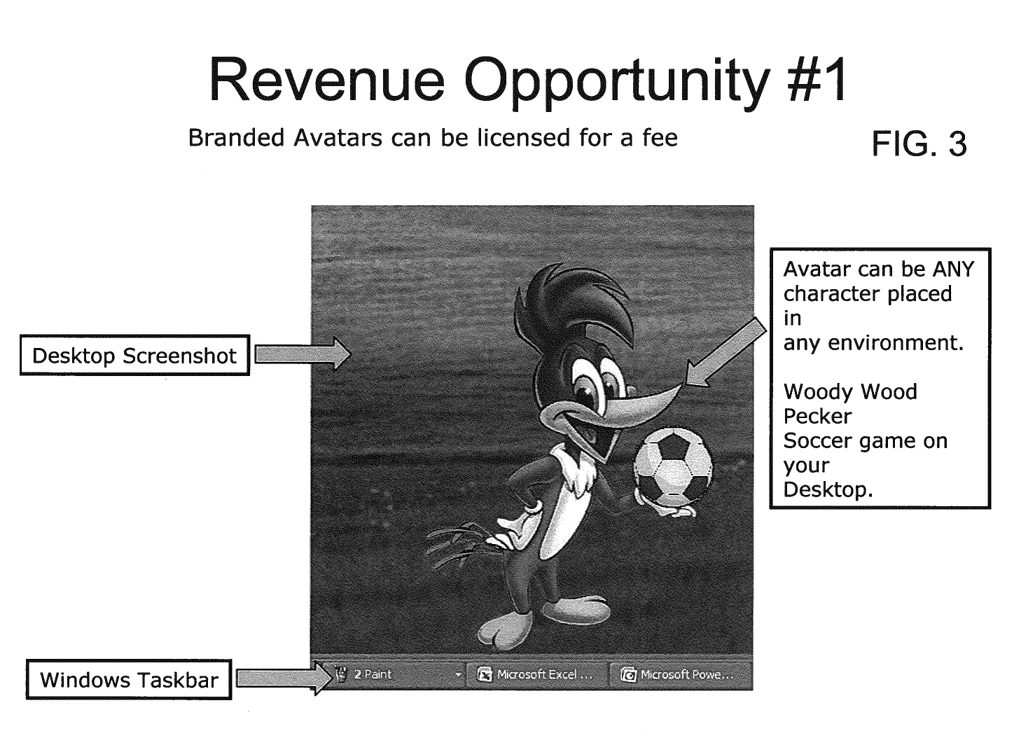

The avatars come equipped with standard features and functions that, possibly for a fee or via micro-transaction, may be enhanced with additional functionality and features. Such upgrades include accessories such as hats, glasses, etc., or behaviors and abilities such as being able to move windows on desktops or being able to climb and move objects on the screen. The avatars can also come with more sophisticated enhancements. For example, in FIG. 3, a Woody Wood Pecker avatar can be downloaded and, for an additional fee, enhanced with a soccer game complete with animated soccer ball that can be played on the desktop. It may also be possible for the user to program certain functions or features using tools like scripts in the respective application programming interfaces (APIs) on which the avatars are displayed.

While interactive avatars are implemented in software, they have to run on a real computer or other hardware device (such as a smartphone or PDA) to perform their function. They run as a client application on the host machine or device (the one currently displaying the avatar). The client application is implemented using the application programming interfaces (APIs) of the respective operating system (e.g., Windows, Mac) or device (e.g., iPhone, Nintendo DS, Sony PSP) on which the client application is running. Users interested in experiencing such avatars must have this client application running not only on their systems, but also on the systems of any other users on which they wish their avatars to appear. The client application also has to run on any other devices of theirs from which they wish to experience the interactive avatars (e.g., their smartphones, PDAs, or other portable computing devices such as laptop computers). Interactive avatars can also integrate into existing instant messaging programs (through corresponding API) including AOL IM, MSN, Yahoo Messenger, etc.

A preferred embodiment of the interactive avatar is as a client application on a computer screen, in particular a Windows desktop. While numerous other embodiments can be conceived, such as smartphones, PDAs, Mac displays, and the like, for purposes of illustration and not limitation, most of the interactive avatar's example function and features will be framed in terms of this preferred embodiment. The term “interactive avatar” will therefore be synonymous with “desktop avatar,” though such avatars are capable of running on systems, other than computer (Windows) desktops. There are several client applications, all linked together through a common communications network, such as the Internet, to permit sharing and displaying of multiple avatars on different desktops.

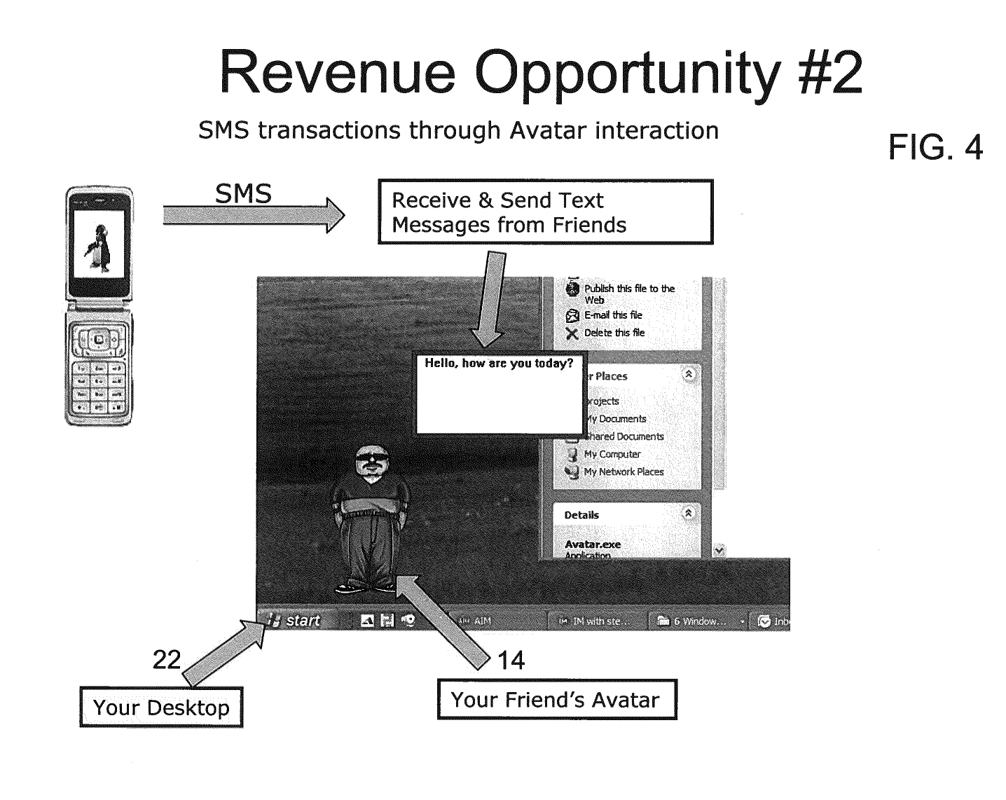

The interactive avatars can be made available from a central server, which downloads a user-selected avatar to a target system (say, a friend's desktop) after a user registers online with the server. Here, a “friend” is someone who registers the user as a friend to their network. This, then, invokes the client application on the friend's desktop to portray the user's avatar on the friend's display, permitting such functions as:
Controlling or moving active windows on the friend's computer
Inviting friends to play games
Sending flowers or gifts on special occasions
Sending personal text messages and leaving voicemail messages (see, for example, FIG. 4 for an example text message application)
Using avatars as personal reminders
Purchasing different behaviors and items through the server to augment the avatar, such as
   Purchasing flowers and gifts for loved ones
   Upgrading the avatar's looks, or adding new clothing
   Purchasing and playing games (see, for instance, FIG. 3)

The interactive avatar can “live” on another user's desktop, subject to permission by the other user. This is all under the control of the client application, which prompts a prospective host prior to allowing a “guest” avatar to appear on the desktop. A user (on a “sending” desktop) can send their interactive avatar to another user's desktop (the host desktop). If the other user gives permission, then the client application on the host (other user's) machine causes the avatar to take form on the other user's screen while the user can see outlines of the avatar and the other user's windows and icons from the user's screen, this time through the sending machine's interactive avatar client application.

The notion that an interactive avatar might only exist on one screen at a time helps preserve an important function of the avatar: its ability to represent the user in lifelike qualities (such as being subject to direct control by the user, or allowing the user to speak or communicate directly through the avatar) as if the avatar were the user. The client applications, which work cooperatively among themselves through the communications network (e.g., Internet), can ensure that this “single screen” property is preserved. The client applications can also preserve appearances and functionality of the interactive avatars across different hosting platforms. Note that it is also perfectly possible for two different users to each place their own avatar on a third user's screen, and for these two avatars to interact on the third user's screen. For instance, avatars can be given the ability to engage in virtual fights or contests (like those in computer games) on the user's desktop. One user can send their avatar and try to virtually overpower other avatars in order to take control of the desktop or to take from the other avatars valuable collectibles or accessories.

A single client application is thus capable of displaying and having multiple avatars interact from the same or multiple users. Individual avatars, however, may still be limited to displaying on only one such client application at a time. Alternative embodiments, however, may permit more concurrency: for instance, permitting an avatar to exist in a virtual world and a desktop at the same time, or in a virtual world and multiple smartphones (including iPhones) at the same time.

The avatar can be controlled interactively. That is, the user can input commands (say, from menus, or under the control of a pointing device such as a mouse or trackball) from their screen and cause the avatar to respond on the other user's screen. This also causes the user to see the outline of the avatar's actions as well as the effect of the avatar's actions on the other users' screen. In this respect, the user is acting as the avatar's master. The user is also free to communicate through the avatar (using text or voice, which can be their voice or some transformed voice) on the other user's screen.

The avatar application comes with certain functions, such as the ability to move or reshape windows in mildly disruptive ways, on the other user's screen. See, for instance, FIG. 2. Other functions may include animation sequences (such as gestures), game playing (e.g., chess, real-time trivia, and others), chat (voice or text), etc. For instance, one such application is when the avatar moves around a depiction of a ball (such as a soccer ball or beach ball) on the other user's screen (say, in gaps between windows). In another such application through avatars, online users can participate in real-time trivia games. Users are given a few moments before they have to answer questions that were delivered by their avatar by either a server back-end or other friends.

Examples of other features and functions include:
Walk, Run, Sit, Sleep, or Climb, together with any combination of additional animation.
Users can send messages to each other via the avatars; messages can be displayed on screen or can be converted to speech (text to speech).
Avatars can also read e-mails or convert e-mail text to speech.
Avatars have the ability to interact with objects on the desktop, such as moving windows and icons and arrange them in any order that has been instructed to them.
Avatars have the ability to take part in games and in any number of interactive entertainment scenarios as instructed by computer code.
Users have the ability to write instructions for the avatars to follow. These are called scripts that can be sent over e-mail or left on the server for the avatar to follow once the user is online.
In addition to PC & Mac, the avatars can also be run on smartphones, PDAs, Nintendo DS, Sony PSP, and other devices.
This technology has the ability to capture a user's desktop state and send it over the interne or wirelessly to another machine. The desktop capture will transmit the current state of all the objects on the user's machine in terms of location and dimension. This information can be available to the avatar so that the application can interact with it accordingly. Note that the contents of the objects are not transmitted.

Note that such games or other applications can be quite sophisticated. For instance, the application can keep a certain folder on the hard-drive of the corresponding computer on which the application is running that is protected and only accessible by the interactive avatars. This can permit certain other files that are downloaded and saved in that folder to be accessed by other avatars depending on the rules and circumstances of the particular application.

For privacy reasons, the user should not be able to see the contents of the other user's windows or icons, only their edges (exterior shapes) of the windows. In addition, to limit disruption on the other user's screen, the other user should have the ability to disable the avatar's function (preferably feature by feature, such as by graying out functions or areas of control on the user's screen), including terminating the avatar, or to restore the screen to its predisrupted state. Again, this is all under the control of the client application. One of the useful features of interactive avatars is their ability to enhance communication between users in everyday situations, such as when operating a computer or communicating by video-enhanced means, as with VoIP. Since communication is usually a two-way exchange, the interactive avatar implementation should be responsive to each user's needs.

The avatar can also be controlled automatically, through such mechanisms as scripts. This way, the avatar can perform predefined behaviors either triggered by time or other events, while the user is away from the screen or not interested in direct control. The user is free to switch at anytime between direct control of the avatar and allowing the avatar to behave more as an automaton.

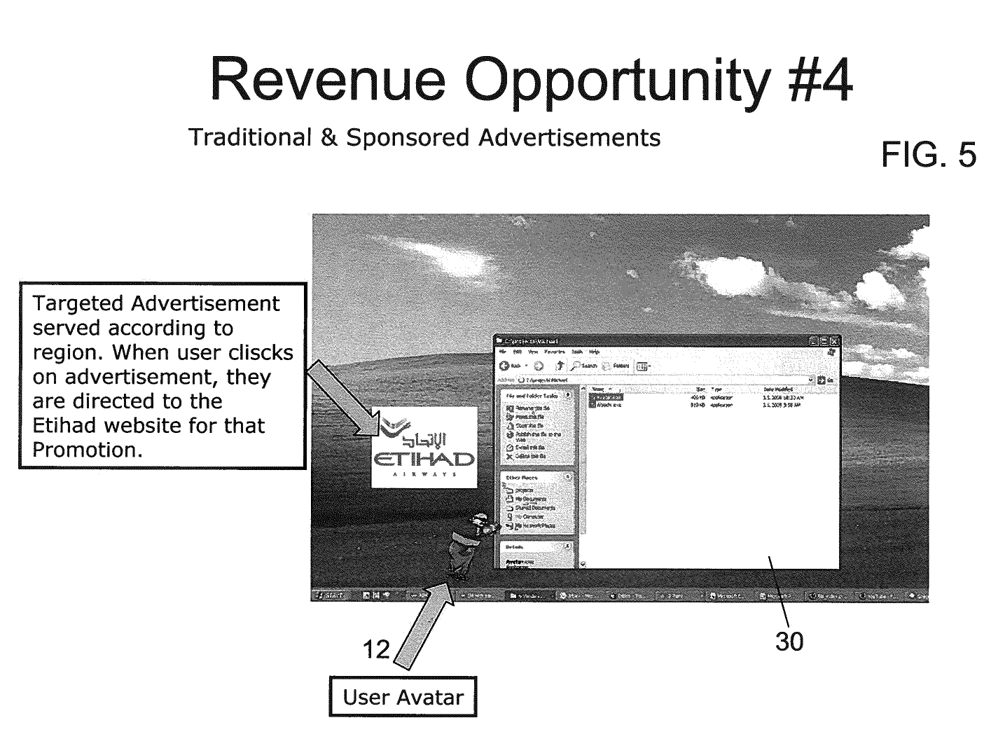

In another embodiment, interactive avatars can be licensed by marketing companies to use for promotional purposes. Users would download these avatars through a central server and get to use and customize such interactive avatars to do interesting, useful, and fun activities like games, communicating, or interactive manipulations on other users' desktops. In the meantime, the companies can use the avatars to promote their products or services through advertising, thus reaching specialized audiences that might otherwise not be accessible. See, for example, FIG. 5.

The marketing companies could obtain interesting and useful demographic data about the users who download their avatars by having the downloading application capture such demographic data (including the location to where they are downloaded) prior to downloading, and then sharing this information with the corresponding marketing companies. The companies could, for example, use the avatars to:
Send direct marketing messages to users in real-time
Sell targeted advertisement and sponsorships according to a particular marketing region
Promote targeted sales of products and services
Collect valuable real-time data on customers
License interactive avatars to partner companies and share revenue
Push scheduled marketing messages
Play video—Stream video
Play audio—Stream audio

In another embodiment, companies can provide avatar services that users could partake in on a micro-transaction basis. Micro-transactions are low-cost electronic transactions that are handled by specialized accounting applications to minimize the overhead involved in typical Internet-based e-commerce transactions (say, by aggregating numerous such micro-transactions, or by using some form of electronic currency that can be purchased in large quantities using a typical electronic transaction and then managed in much smaller portions in the micro-transaction application). Such micro-transactions include:
Upgrade an ability or behavior of an avatar, e.g.,
   Add facial or expression behavior
   Provide ability to interact with desktop objects
Pay for avatar games, such as avatar golf
Purchase goods (e.g., flowers, tickets)
Send text messages to other avatars
Pay to compete in games and win
Sports-related transactions
News-related transactions
Religion subscriptions
Fashion-related transactions

In yet another embodiment, interactive avatars can be programmed by their users through scripts, which implement new routines or features using an API provided by the client application. This allows further customization of interactive avatars. The API could be implemented to restrict the type of customization possible. This way, companies that license the use of their avatars (say, for works protected under copyright) could prevent their avatars from doing or appearing in various forms that the companies might find inappropriate (e.g., damaging to the value of their copyright).

Although the present invention has been described in considerable detail with reference to certain exemplary embodiments, other embodiments are possible.

Although certain exemplary embodiments of the present invention have been disclosed for illustrative purposes, those skilled in the art will appreciate that various modifications, additions and substitutions are possible, without departing from the scope and spirit of the invention as disclosed in the accompanying claims, and equivalents thereof.

What is claimed is:

1. A system for interactive electronic communication between computers over an electronic communications network, comprising:
a local computer comprising a local display device, a local processing unit, and local electronic storage means configured to run an operating system on the local processing unit and display a local desktop on the local display device; and
an interactive avatar application adapted to:
run on the operating system and display a local avatar belonging to a local user of the local computer on the local desktop;
communicate with a remote user on a remote computer comprising a remote display device and configured to display a remote desktop;
allow the remote user to display a remote avatar belonging to the remote user on the local desktop;
allow the remote user to see portions of the local desktop on the remote desktop; and
allow the remote user to use the remote avatar to manipulate the local desktop from the remote desktop.
